(19) United States
(12) Patent Application Publication
(10) Pub. No.: US 2024/0343225 A1
(43) Pub. Date: Oct. 17, 2024

(54) WASHER NOZZLE MOUNTING STRUCTURE FOR VEHICLE

(71) Applicants: SHIGERU CO., LTD., Ota-shi (JP); SUBARU CORPORATION, Tokyo (JP)

(72) Inventors: Yujiro MORIOKA, Ota-shi (JP); Daisuke SAWADA, Tokyo (JP)

(21) Appl. No.: 18/630,514

(22) Filed: Apr. 9, 2024

(30) Foreign Application Priority Data
Apr. 13, 2023 (JP) 2023-065648

(51) Int. Cl. B60S 1/52

(52) U.S. Cl. CPC B60S 1/52

(57) ABSTRACT

A diffusion nozzle through which washer liquid is ejected onto a front window glass of a vehicle and a jet nozzle through which the washer liquid is ejected onto the front window glass of the vehicle are respectively mounted in a first mounting hole portion and a second mounting hole portion formed in a cowl portion. The diffusion nozzle includes a head portion in which an ejection hole is formed and an insertion tube portion protruded from a bottom surface of the head portion and to be inserted in the first mounting hole portion. The jet nozzle includes a head portion in which an ejection hole is formed and an insertion tube portion protruded from a bottom surface of the head portion and to be inserted in the second mounting hole portion. The first mounting hole portion has a shape that does not allow the insertion tube portion of the jet nozzle to be inserted therein. The second mounting hole portion is formed in a bottom portion of a recessed portion disposed in the cowl portion. The recessed portion has dimensions that do not allow the head portion of the diffusion nozzle to be inserted therein.

### CROSS-REFERENCE TO RELATED APPLICATIONS

The present application claims priority from Japanese Patent Application No. 2023-065648 filed on Apr. 13, 2023, the entire contents of which are hereby incorporated by reference.

### BACKGROUND

The present disclosure relates to a structure for mounting a washer nozzle onto a vehicle body, wherein washer liquid is ejected onto a window glass of a vehicle through the washer nozzle.

A vehicle such as an automobile is provided with a window washer apparatus including a pump and a washer nozzle. Washer liquid stored in an in-vehicle tank is transferred to the washer nozzle by the pump and ejected onto a window glass. The washer liquid washes away dust and dirt on a glass surface and serves to prevent a windshield wiper blade from pushing the dust and dirt onto the glass and scratching the glass.

Recently, driving support systems for vehicles such as automobiles become popular. A driving support system is provided with an imaging device such as a camera for cognizing a situation outside of the vehicle. The imaging device is mounted inside the vehicle, for example, inside a front window glass. Accordingly, it is required that an ejection range of washer liquid ejected through a washer nozzle should cover an imaging region of the imaging device as well as wiper wiping regions on a driver side and on a passenger side.

Publication of Japanese Utility Model Registration No. 3204710 discloses a window washer apparatus 1 shown in FIG. 10. The window washer apparatus 1 includes two first nozzles 4a, 4a and one second nozzle 4b disposed in a cowl portion 3 in front of a front window glass 2 as washer nozzles. The first nozzles 4a, 4a are spaced from each other in a vehicle-width direction. The second nozzle 4b is disposed in a middle of the cowl portion 3 in the vehicle-width direction.

Targets of ejection of the first nozzles 4a, 4a are wiper wiping regions 5a, 5a on a driver side and on a passenger side respectively. The first nozzles 4a, 4a diffuse washer liquid 6a like a shower and eject the washer liquid 6a onto the targets of ejection.

The second nozzle 4b ejects washer liquid 6b linearly onto an imaging region 5b, which is a target of ejection.

The first and second nozzles 4a, 4b respectively have head portions 4ah, 4bh with ejection holes respectively formed therein. The head portions 4ah, 4bh respectively have insertion tube portions 4ai, 4bi protruded downward from bottom surfaces thereof. The insertion tube portions 4ai, 4bi are respectively inserted into mounting hole portions formed in the cowl portion 3, thereby, the first and second nozzles 4a, 4b are mounted in the cowl portion 3.

### SUMMARY

One embodiment of the present disclosure provides a mounting structure for a washer nozzle for a vehicle. The mounting structure includes a first nozzle through which washer liquid is ejected onto a window glass of a vehicle and a second nozzle through which washer liquid is ejected onto the window glass of the vehicle. The first nozzle is mounted in a first mounting hole portion formed in a body panel. The second nozzle is mounted in a second mounting hole portion formed in the body panel.

The first nozzle includes a head portion in which an ejection hole is formed and an insertion tube portion protruded from a bottom surface of the head portion and to be inserted in the first mounting hole portion.

The second nozzle includes a head portion in which an ejection hole is formed and an insertion tube portion protruded from a bottom surface of the head portion and to be inserted in the second mounting hole portion.

The first mounting hole portion has a shape that does not allow the insertion tube portion of the second nozzle to be inserted therein.

The second mounting hole portion is formed in a bottom portion of a recessed portion disposed in the body panel. The recessed portion has dimensions that do not allow the head portion of the first nozzle to be inserted therein.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a plan view of a mounting structure for a washer nozzle for a vehicle according to one embodiment of the present disclosure.

FIG. 2A is an enlarged view of a circular portion IIA of FIG. 1.

FIG. 2B is an enlarged view of a circular portion IIB of FIG. 1.

FIG. 3A is a cross-sectional view taken along line IIIA-IIIA of FIG. 2A, shown with an inner structure of a first nozzle omitted.

FIG. 3B is a cross-sectional view taken along line IIIB-IIIB of FIG. 2B, shown with an inner structure of a second nozzle omitted.

FIG. 4A is an enlarged view of the circular portion IIA of FIG. 1, showing a cross-section of the first nozzle with the inner structure thereof omitted.

FIG. 4B is an enlarged view of the circular portion IIB of FIG. 1, showing a cross-section of the second nozzle with the inner structure thereof omitted.

FIG. 5A is an enlarged front view of the first nozzle.

FIG. 5B is an enlarged right side view of the first nozzle.

FIG. 5C is an enlarged bottom view of the first nozzle.

FIG. 5D is an enlarged perspective view of the first nozzle.

FIG. 6A is an enlarged front view of the second nozzle.

FIG. 6B is an enlarged right side view of the second nozzle.

FIG. 6C is an enlarged bottom view of the second nozzle.

FIG. 6D is an enlarged perspective view of the second nozzle.

FIG. 7A is an enlarged plan view, showing a first mounting hole portion.

FIG. 7B is an enlarged plan view, showing a second mounting hole portion.

FIG. 8A is a cross-sectional view taken along line VIIIA-VIIIA of FIG. 7A.

FIG. 8B is a cross-sectional view taken along line VIIIB-VIIIB of FIG. 7B.

FIG. 8C is a drawing comparing FIG. 8A and FIG. 8B.

FIG. 9A is a drawing comparing a cross-section of the first mounting hole portion and a cross-section of a basal end portion of an insertion tube portion of the second nozzle.

FIG. 9B is a drawing comparing a recessed portion having the second mounting hole portion therein and a head portion of the first nozzle.

FIG. 10 is a plan view of a conventional mounting structure for a washer nozzle for a vehicle.

### DETAILED DESCRIPTION

In the window washer apparatus 1 disclosed in the Publication of Japanese Utility Model Registration No. 3204710, specifications of the first nozzle 4a and the second nozzle 4b are different. However, shapes of mounting hole portions of the cowl portion 3 in which the nozzles 4a, 4b are respectively mounted are same. Therefore, the first nozzle 4a and the second nozzle 4b could be mounted in wrong mounting holes that are not their respective proper mounting holes by mistake. It is desired to provide a mounting structure for washer nozzles for a vehicle that solves the problem mentioned above.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

A mounting structure for washer nozzles for a vehicle according to one embodiment of the present disclosure is described hereinafter with reference to the drawings. In this embodiment, the present disclosure is applied to a mounting structure for washer nozzles onto a cowl portion of an automobile. In the following description, front-rear and left-right directions are determined in accordance with front-rear and left-right directions of a vehicle.

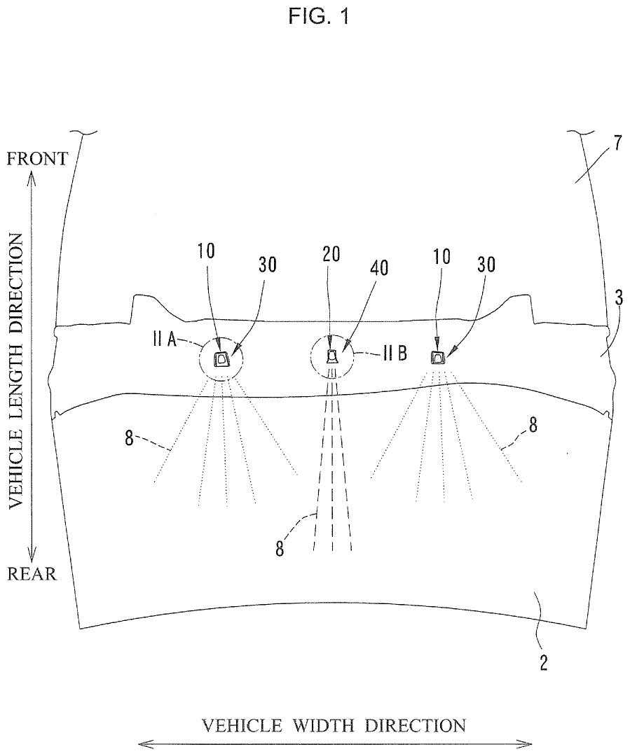

As shown in FIG. 1, a cowl portion 3 (body panel) of an automobile (vehicle) is disposed between a front end of a front window glass 2 and a rear end of a front hood 7 with a longitudinal direction thereof coinciding with a vehicle-width direction. The cowl portion 3 is made of injection-molded resin. As washer nozzles through which washer liquid is ejected onto the front window glass 2, two diffusion nozzles 10, 10 (first nozzles) and one jet nozzle 20 (second nozzle) are mounted in the cowl portion 3. The diffusion nozzles 10, 10 are disposed spaced from each other in the vehicle-width direction. The jet nozzle 20 is disposed in a middle portion in the vehicle-width direction between the diffusion nozzles 10, 10.

The diffusion nozzles 10,10 diffuse washer liquid 8 like a shower and eject the washer liquid 8 in a wide range. Targets of ejection of the diffusion nozzles 10, 10 are wiper wiping regions of the front window glass 2 on a driver side and on a passenger side.

The jet nozzle 20 ejects the washer liquid 8 linearly in a narrow range. A target of ejection of the jet nozzle 20 is one region of the front window glass 2. The one region may be, for example, a region that can be imaged by an imaging device such as a camera mounted inside the vehicle inside the front window glass 2.

Detailed description will be provided hereinafter under the following subheadings: [1. Mounting Structure for the Diffusion Nozzle 10]; [2. Mounting Structure for the Jet Nozzle 20]; [3. When the Jet Nozzle 20 is Tried to be Mounted in the Mounting Location for the Diffusion Nozzle 10]; [4. When the Diffusion Nozzle 10 is Tried to be Mounted in the Mounting Location for the Jet Nozzle 20]; [5. Effects of the Embodiment]; [6. Modifications]

### 1. MOUNTING STRUCTURE FOR DIFFUSION NOZZLE 10

Detailed description will be provided hereinafter under the following subheadings: (1-1. Shape of the Diffusion Nozzle 10); (1-2. Mounting Location of the Diffusion Nozzle 10); (1-3. Mounting of the Diffusion Nozzle 10)

### 1-1. Shape of the Diffusion Nozzle 10

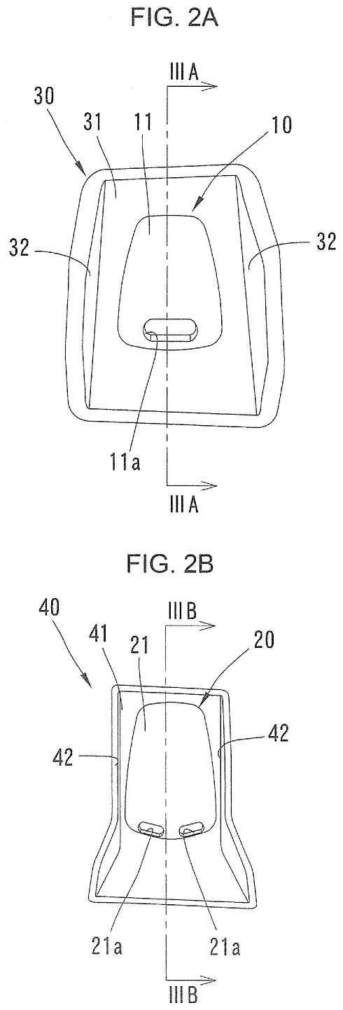

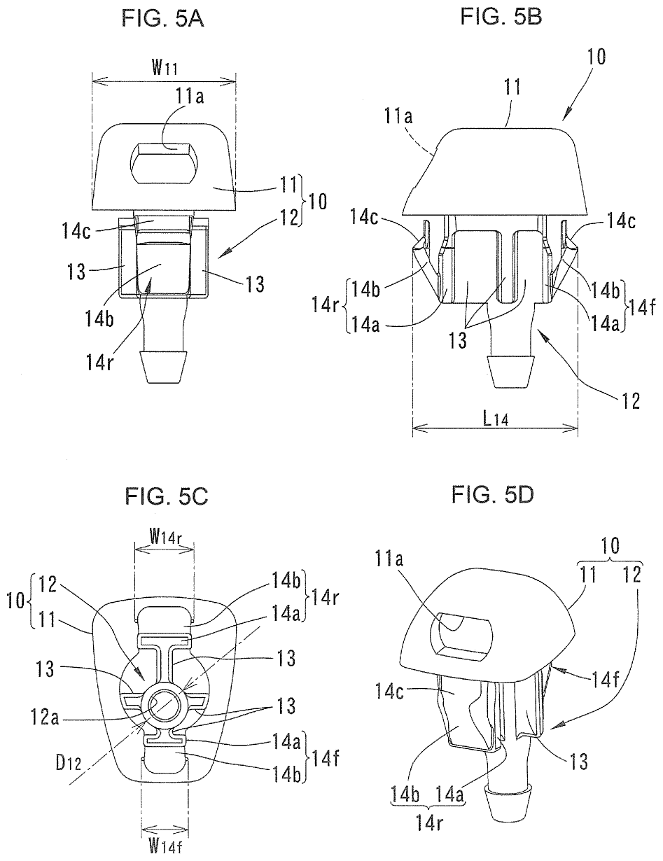

The diffusion nozzle 10 is made of resin and flexible. As shown in FIGS. 5A to 5D in enlarged views, the diffusion nozzle 10 includes a head portion 11 and an insertion tube portion 12 protruded from a flat bottom surface of the head portion 11. As shown in FIGS. 2A and 5C, the head portion 11 has an elongated trapezoidal configuration with rounded corners in plan view or in bottom view and, as shown in FIG. 5A, has a width W₁₁. The head portion 11 has an ejection hole 11a formed in one side portion thereof in a longitudinal direction in plan view (bottom view). The ejection hole 11a is an upward-slanting opening through which the washer liquid is ejected.

As shown in FIGS. 5A to 5D, four spacer portions 13 are disposed in a basal end portion of the insertion tube portion 12. The spacer portions 13 have configurations of plates protruded in radial directions and extending along an axial direction. The spacer portions 13 are protruded in the longitudinal direction and in a short direction of the head portion 11 in plan view (bottom view). Two spacer portions 13 on the longitudinal side respectively have engagement portions 14r, 14f disposed in distal ends thereof in the direction of protrusion. The engagement portions 14r, 14f are continuous from the distal ends of the two spacer portions 13. As shown in FIG. 5C, the basal end portion of the insertion tube portion 12 has an outer diameter D₁₂.

The engagement portions 14r, 14f respectively include support plate portions 14a, 14a and respectively include engagement claw portions 14b, 14b. The support plate portion 14a is continuous from the spacer portion 13 with plate surfaces thereof orthogonally extending. The engagement claw portions 14b, 14b having plate-like configurations respectively extend from lower end portions of the support plate portions 14a, 14a. Each of the engagement claw portions 14b is formed so as to be more distanced from the insertion tube portion 12 toward upward. The engagement claw portions 14b, 14b are elastically deformable to be closer to the insertion tube portion 12.

An outer surface of an upper end portion of each of the engagement claw portions 14b extends closer to the insertion tube portion 12 toward upward until a certain point and then generally in parallel to the support plate portion 14a. Accordingly, a step is formed, which serves as an abutment surface 14c. As shown in FIG. 5B, outer surfaces of the engagement claw portions 14b, 14b have a maximum distance L₁₄ therebetween.

As shown in FIG. 5C, a width W₁₄ᵣ of one engagement portion 14r on the ejection hole 11a side is greater than a width W_{14f} of the other engagement portion 14f (W₁₄ᵣ>W_{14f}). Alternatively, the width W_{14f} of the other engagement portion 14fmay be greater than the width W₁₄ᵣ of the one engagement portion 14r.

As shown in FIG. 5C, an inflow hole 12a is formed in a distal end surface of the insertion tube portion 12. The inflow hole 12a is communicated with the ejection hole 11a of the head portion 11. A tube (not shown) continuous from a pump (not shown) that pumps out the washer liquid stored in an in-vehicle tank is mounted in a distal end portion of the insertion tube portion 12.

### 1-2. Mounting Location of the Diffusion Nozzle 10

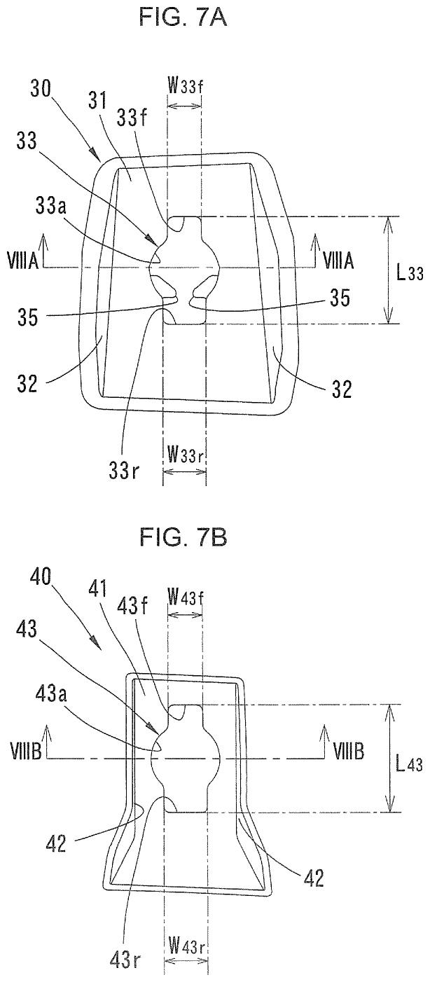

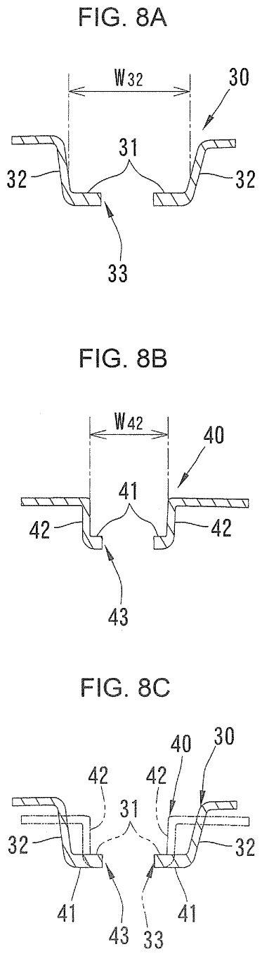

As shown in FIGS. 1 and 2A, the cowl portion 3 has two large recessed portions 30, 30 formed therein as mounting locations of the diffusion nozzles 10, 10. The large recessed portions 30, 30 are disposed spaced from each other in the vehicle-width direction. As shown in FIGS. 7A and 8A, each of the large recessed portions 30 includes a bottom portion 31 and side wall portions 32, 32 raised from opposite ends of the bottom portion 31 in the vehicle-width direction.

The bottom portion 31 has an elongated configuration elongated in a vehicle-length direction. As shown in FIG. 8A, a width W₃₂ between the side wall portions 32, 32 is greater than the width W₁₁ (FIG. 5A) of the head portion 11 of the diffusion nozzle 10 (W₃₂>W₁₁). Accordingly, as shown in FIG. 2A, the head portion 11 of the diffusion nozzle 10 can be inside the large recessed portion 30.

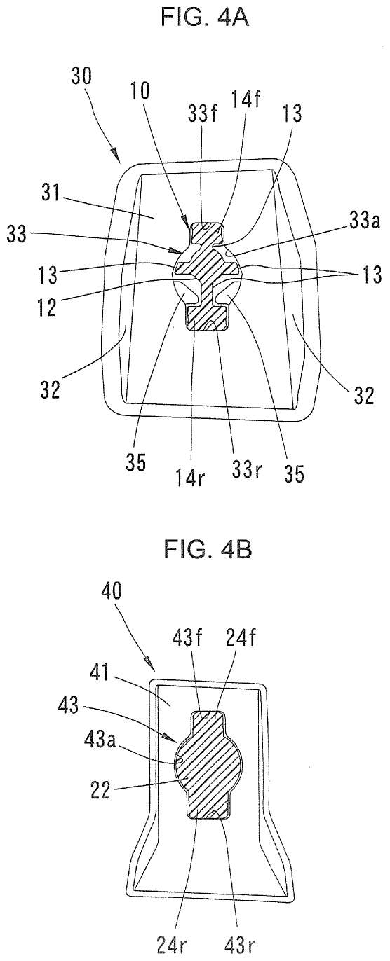

The bottom portion 31 serves as a mounting surface against which the bottom surface of the head portion 11 of the diffusion nozzle 10 is abutted. As shown in FIGS. 4A and 7A, the bottom portion 31 has a mounting hole portion 33 (first mounting hole portion) formed therein. The mounting hole portion 33 includes a central hole portion 33a and cut-out portions 33r, 33f. The insertion tube portion 12 and the spacer portion 13 of the diffusion nozzle 10 can be inserted through the central hole portion 33a. The cut-out portions 33r, 33f are formed so as to cut out a peripheral edge portion of the central hole portion 33a in rectangular configurations.

As shown in FIG. 4A, the central hole portion 33a has a diameter slightly greater than a length between distal ends of the spacers 13, 13 protruded from the basal end portion of the insertion tube portion 12 of the diffusion nozzle 10 in the short direction of the head portion 11 in plan view (bottom view).

The cut-out portions 33r, 33f are formed so as to be opposed in a radial direction of the central hole portion 33a. The cut-out portions 33r, 33f are opposed in the vehicle-length direction in this embodiment. A distance L₃₃ (FIG. 7A) between the cut-out portions 33r, 33f in the vehicle-length direction is smaller than the maximum distance L₁₄ (FIG. 5B) between the outer surfaces of the engagement claw portions 14b, 14b of the diffusion nozzle 10 (L₃₃<L₁₄).

As shown in FIG. 7A, a width W₃₃ᵣ of the cut-out portion 33r on the rear side is greater than a width W_{33f} of the cut-out portion 33f on the front side (W₃₃ᵣ>W_{33f}). The width W₃₃ᵣ is generally same as or slightly greater than the width W₁₄ᵣ (FIG. 5C) of the one engagement portion 14r of the diffusion nozzle 10.

The width W_{33f} of the cut-out portion 33f on the front side is generally same as or slightly greater than the width W_{14f} (FIG. 5C) of the other engagement portion 14f of the diffusion nozzle 10 and is smaller than the width W₁₄ᵣ (FIG. 5C) of the one engagement portion 14r (W_{33f}<W₁₄ᵣ). Accordingly, the other engagement portion 14f can be inserted through the cut-out portion 33f on the front side, but the one engagement portion 14r cannot be inserted through the cut-out portion 33f on the front side. This arrangement prevents the diffusion nozzle 10 from being mounted in a wrong orientation in the vehicle-length direction (front-rear direction).

When the diffusion nozzle 10 is formed such that the width W_{14f} of the other engagement portion 14f is greater than the width W₁₄ᵣ of the one engagement portion 14r, the width W_{33f} of the cut-out portion 33f on the front side is formed so as to be greater than the width W₃₃ᵣ of cut-out portion 33r on the rear side.

As shown in FIGS. 4A and 7A, obstacle portions 35 protruded toward an inside of the central hole portion 33a are provided in the peripheral edge portion of the central hole portion 33a. The obstacle portions 35 are provided to block the jet nozzle 20 from being mounted in the mounting hole portion 33. In this embodiment, a pair of obstacle portions 35 are disposed respectively in portions of the central hole portion 33a adjacent to the cut-out portion 33r on the rear side. The obstacle portions 35 are opposed to each other in the vehicle-width direction. Alternatively, the pair of obstacle portions 35, 35 may be disposed respectively in portions of the central hole portion 33a adjacent to the cut-out portion 33f on the front side. Alternatively, one of the obstacle portions 35 may be disposed in the portion of the central hole portion 33a adjacent to the cut-out portion 33f on the rear side and the other of the obstacle portions 35 may be disposed in the portion of the central hole portion 33a adjacent to the cut-out portion 33f on the front side.

In this embodiment, each of the obstacle portions 35 has a wedge-shaped configuration in plan view. The pair of obstacle portions 35, 35 are disposed in the central hole portion 33a such that the obstacle portions 35, 35 are not contacted with imaginary lines extending in the vehicle-width direction and the vehicle-length direction in the radial direction. Shapes and dimensions of the obstacles 35, 35 are determined so as not to interfere with the basal end portion of the insertion tube portion 12 and the spacer portions 13 of the diffusion nozzles 10 to be inserted to the central hole portion 33a. The number of the obstacle portions 35 provided may be one or may be three or more.

### 1-3. Mounting of the Diffusion Nozzle 10

When the ejection hole 1la of the head portion 11 of the diffusion nozzle 10 is oriented rearward to the front window glass 2 side above the large recessed portion 30 of the cowl portion 3, the engagement portions 14r, 14f of the diffusion nozzle 10 are respectively located above the cut-out portions 33r, 33f of the mounting hole portion 33. When the diffusion nozzle 10 is lowered in this state, the insertion tube portion 12 and the spacer portions 13 are inserted into the central hole portion 33a without interfering with the obstacle portions 35. At this time, the engagement portions 14r, 14f are inserted into the cut-out portions 33r, 33f. The engagement claw portions 14b, 14b are abutted against edge portions of the cut-out portions 33r, 33f and elastically deformed so as to be closer to the insertion tube portion 12.

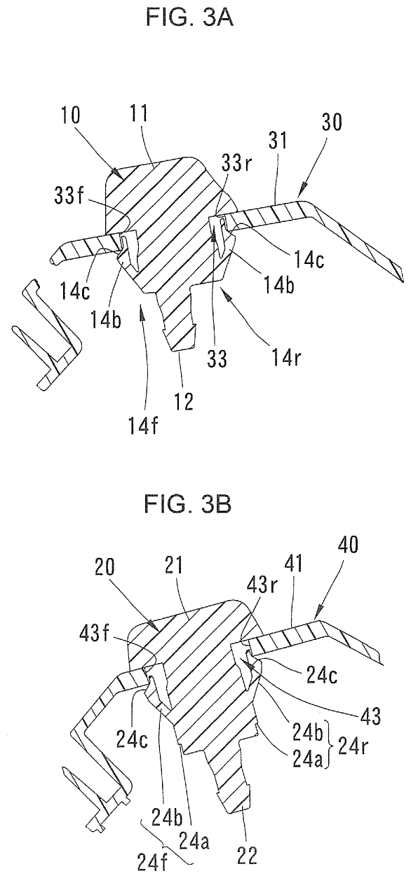

As shown in FIG. 3A, when the abutment surface 14c of each of the engagement claw portions 14b reaches a back side of the bottom portion 31, each of the engagement claw portions 14b is elastically restored so as to be spaced from the insertion tube portion 12. This causes the abutment surfaces 14c, 14c to be respectively abutted against the edge portions of the cut-out portions 33r, 33f. At this time, the bottom surface of the head portion 11 of the diffusion nozzle 10 is abutted against the bottom portion 31 of the large recessed portion 30, thereby, the diffusion nozzle 10 is mounted in the mounting hole portion 33 in a retained condition.

### 2. MOUNTING STRUCTURE FOR JET NOZZLE

Detailed description will be provided hereinafter under the following subheadings: (2-1. Shape of the Jet Nozzle 20); (2-2. Mounting Location of the Jet Nozzle 20); (2-3. Mounting of the Jet Nozzle 20)

### 2-1. Shape of the Jet Nozzle 20

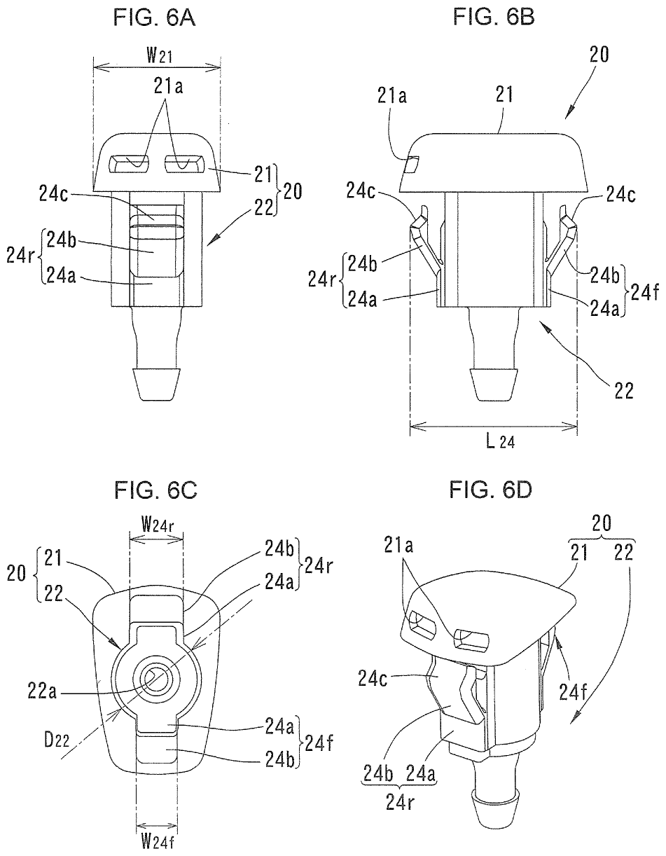

The jet nozzle 20 is made of resin and flexible. As shown in FIGS. 6A to 6D in enlarged views, the jet nozzle 20 includes a head portion 21 and an insertion tube portion 22 protruded from a flat bottom surface of the head portion 21. As shown in FIGS. 2B and 6C, the head portion 21 has an elongated trapezoidal configuration with rounded corners in plan view or in bottom view and, as shown in FIG. 6A, has a width W₂₁. The head portion 21 has two ejection holes 21a, 21a formed in one side portion thereof in a longitudinal direction in plan view (bottom view). The ejection holes 21a, 21a are upward-slanting openings through which the washer liquid is ejected. The width W21 of the head portion 21 of the jet nozzle 20 is smaller than the width W₁₁ (FIG. 5A) of the head portion 11 of the diffusion nozzle 10 (W₂₁<W₁₁).

As shown in FIGS. 6A to 6D, an outer diameter of a basal end portion of the insertion tube portion 22 is greater than an outer diameter of a distal end portion of the insertion tube portion 22. The outer diameter D₂₂ of the basal end portion of the insertion tube portion 22 (FIG. 6C) is greater than the outer diameter D₁₂ of the basal end portion of the insertion tube portion 12 of the diffusion nozzle 10 (FIG. 5C) (D₂₂>D₁₂). The insertion tube portion 22 has two engagement portions 24r, 24f disposed in the basal end portion thereof on portions opposed to each other in the longitudinal direction of the head portion 21 in plan view (bottom view).

The engagement portions 24r, 24f respectively include support plate portions 24a, 24a and respectively include engagement claw portions 24b, 24b.

Each of the support plate portions 24a has a plate surface thereof oriented in a radial direction. The support plate portion 24a is protruded from the basal end portion of the insertion tube portion 22 in the radial direction and extends along an axial direction.

Each of the engagement claw portions 24b having a plate-like configuration extends from a middle portion of the support plate portion 24a in the vertical direction. Each of the engagement claw portions 24b is formed so as to be to be more distanced from the insertion tube portion 22 toward upward. The engagement claw portion 24b is elastically deformable to be closer to the insertion tube portion 22.

An outer surface of an upper end portion of each of the engagement claw portions 24b extends closer to the insertion tube portion 22 toward upward until a certain point and then generally in parallel to the support plate portion 24a. Accordingly, a step is formed, which serves as an abutment surface 24c. As shown in FIG. 6B, outer surfaces of the engagement claw portions 24b, 24b have a maximum distance L₂₄ therebetween.

As shown in FIG. 6C, a width W₂₄ᵣ of one engagement portion 24r on the ejection hole 21a side is greater than a width W_{24f} of the other engagement portion 24f (W₂₄ᵣ>W_{24f}). Alternatively, the width W_{24f} of the other engagement portion 24f may be greater than the width W₂₄ᵣ of the one engagement portion 24r.

As shown in FIG. 6C, an inflow hole 22a is formed in a distal end surface of the insertion tube portion 22. A flow passage is branched inside the jet nozzle 20 to be communicated with the two ejection holes 21a, 21a of the head portion 21. A tube (not shown) continuous from the pump (not shown) that pumps out the washer liquid stored in the in-vehicle tank is mounted in a distal end portion of the insertion tube portion 22.

### 2-2. Mounting Location of the Jet Nozzle 20

As shown in FIGS. 1 and 2B, the cowl portion 3 has a recessed portion 40 formed therein as a mounting location of the jet nozzle 20 in a middle portion in the vehicle-width direction thereof. The recessed portion 40 is disposed between the large recessed portions 30, 30. As shown in FIGS. 7B and 8B, the recessed portion 40 includes a bottom portion 41 and side wall portions 42, 42 raised from opposite ends of the bottom portion 41 in the vehicle-width direction.

The bottom portion 41 has an elongated configuration elongated in the vehicle-length direction. As shown in FIGS. 8A to 8C, a width W₄₂ between the side wall portions 42, 42 is smaller than the width W₃₂ between the side wall portions 32, 32 of the large recessed portion 30 (W₄₂<W₃₂). As shown in FIG. 2B, the width W₄₂ between the side wall portions 42, 42 is greater than the width W₂₁ (FIG. 6A) of the head portion 21 of the jet nozzle 20 and is smaller than the width W₁₁ (FIG. 5A) of the head portion 11 of the diffusion nozzle 10 (W₁₁>W₄₂>W₂₁). Accordingly, as shown in FIG. 2B, the head portion 21 of the jet nozzle 20 can be inside the recessed portion 40, but the head portion 11 of the diffusion nozzle 10 cannot be inside the recessed portion 40. As shown in FIG. 8C, heights of the side wall portions 42, 42 are lower than heights of the side wall portions 32, 32 in this embodiment.

The bottom portion 41 serves as a mounting surface against which the bottom surface of the head portion 21 of the jet nozzle 20 is abutted. As shown in FIGS. 4B and 7B, the bottom portion 41 has a mounting hole portion 43 (second mounting hole portion) formed therein. The mounting hole portion 43 includes a central hole portion 43a and cut-out portions 43r, 43f. The insertion tube portion 22 of the jet nozzle 20 can be inserted through the central hole portion 43a. The cut-out portions 43r, 43f are formed so as to cut out a peripheral edge portion of the central hole portion 43a in rectangular configurations.

In this embodiment, a diameter of the central hole portion 43a is same as the diameter of the central hole portion 33a of the mounting hole portion 33 of the large recessed portion 30. Alternatively, the diameter of the central hole portion 43a may be different from the diameter of the central hole portion 33a. As shown in FIG. 4B, the diameter of the central hole portion 43a is generally same as or slightly greater than the outer diameter D₂₂ (FIG. 6C) of the basal end portion of the insertion tube portion 22 of the jet nozzle 20.

The cut-out portions 43r, 43f are disposed so as to be opposed to each other in a radial direction of the central hole portion 43a. In this embodiment, the cut-out portions 43r, 43f are opposed in the vehicle-length direction. In this embodiment, the cut-out portions 43r, 43f are formed to have same shape and same dimensions as the cut-out portions 33r, 33f of the mounting hole portion 33 of the large recessed portion 30. Alternatively, the shape and the dimensions of the cut-out portions 43r, 43f may be different from the shape and the dimensions of the cut-out portions 33r, 33f. A distance L₄₃ (FIG. 7B) between the cut-out portions 43r, 43f in the vehicle-length direction is smaller than the maximum distance L₂₄ (FIG. 6B) between the outer surfaces of the engagement claw portions 24b, 24b of the jet nozzle 20 (L₄₃<L₂₄).

As shown in FIG. 7B, a width W₄₃ᵣ of the cut-out portion 43r on the rear side is greater than a width W_{43f} of the cut-out portion 43f on the front side (W₄₃ᵣ>W_{43f}). The width W₄₃ᵣ is generally same as or slightly greater than the width W₂₄ᵣ (FIG. 6C) of the one engagement portion 24r of the jet nozzle 20.

The width W_{43f} of the cut-out portion 43f on the front side is generally same as or slightly greater than the width W_{24f} (FIG. 6C) of the other engagement portion 24f of the jet nozzle 20 and is smaller than the width W₂₄ᵣ (FIG. 6C) of the one engagement portion 24r (W_{43f}<W₂₄ᵣ). Accordingly, the other engagement portion 24f can be inserted through the cut-out portion 43f on the front side, but the one engagement portion 24r cannot be inserted through the cut-out portion 43f on the front side. This arrangement prevents the jet nozzle 20 from being mounted in a wrong orientation in the vehicle-length direction (front-rear direction).

When the jet nozzle 20 is formed such that the width W_{24f} of the other engagement portion 24f is greater than the width W₂₄ᵣ of the one engagement portion 24r, the width W_{43f} of the cut-out portion 43f on the front side is formed so as to be greater than the width W₄₃ᵣ of cut-out portion 43r on the rear side.

### 2-3. Mounting of the Jet Nozzle 20

When the ejection holes 21a, 21a of the head portion 21 of the jet nozzle 20 are oriented rearward to the front window glass 2 side above the recessed portion 40 of the cowl portion 3, the engagement portions 24r, 24f of the jet nozzle 20 are respectively located above the cut-out portions 43r, 43f of the mounting hole portion 43. When the jet nozzle 20 is lowered in this state, the insertion tube portion 22 is inserted into the central hole portion 43a. At this time, the engagement portions 24r, 24f are inserted into the cut-out portions 33r, 33f. The engagement claw portions 24b, 24b are abutted against edge portions of the cut-out portions 43r, 43f and elastically deformed so as to be closer to the insertion tube portion 22.

As shown in FIG. 3B, when the abutment surface 24c of each of the engagement claw portions 24b reaches a back side of the bottom portion 41, each of the engagement claw portions 24b is elastically restored so as to be spaced from the insertion tube portion 22. This causes the abutment surfaces 24c, 24c to be respectively abutted against the edge portions of the cut-out portions 43r, 43f. At this time, the bottom surface of the head portion 21 of the jet nozzle 20 is abutted against the bottom portion 41 of the recessed portion 40, thereby, the jet nozzle 20 is mounted in the mounting hole portion 43 in a retained condition.

### 3. WHEN THE JET NOZZLE 20 IS TRIED TO BE MOUNTED IN THE MOUNTING LOCATION FOR THE DIFFUSION NOZZLE 10

As mentioned above, the diameter of the central hole portion 33a of the mounting hole portion 33 to which the diffusion nozzle 10 is mounted is same as the diameter of the central hole portion 43a of the mounting hole portion 43 to which the jet nozzle 20 is mounted. However, the obstacle portions 35 protruded toward the inside of the central hole portion 33a are provided in the peripheral edge portion of the central hole portion 33a (FIG. 7A). Further, the outer diameter D₂₂ (FIG. 6C) of the basal end portion of the insertion tube portion 22 of the jet nozzle 20 is greater than the outer diameter D₁₂ (FIG. 5C) of the basal end portion of the insertion tube portion 12 of the diffusion nozzle 10.

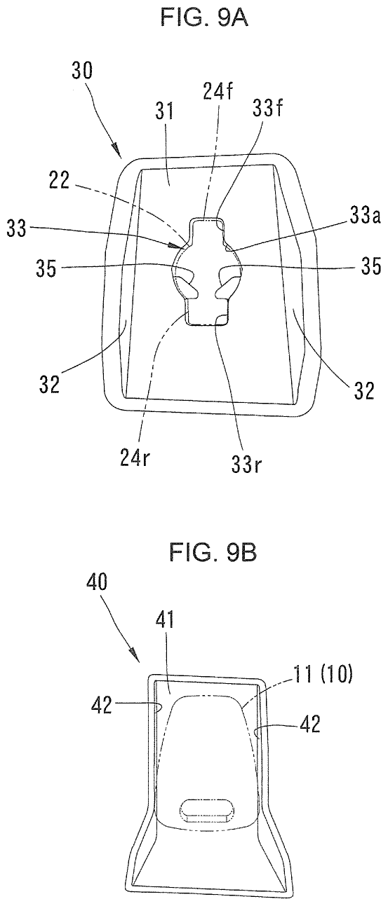

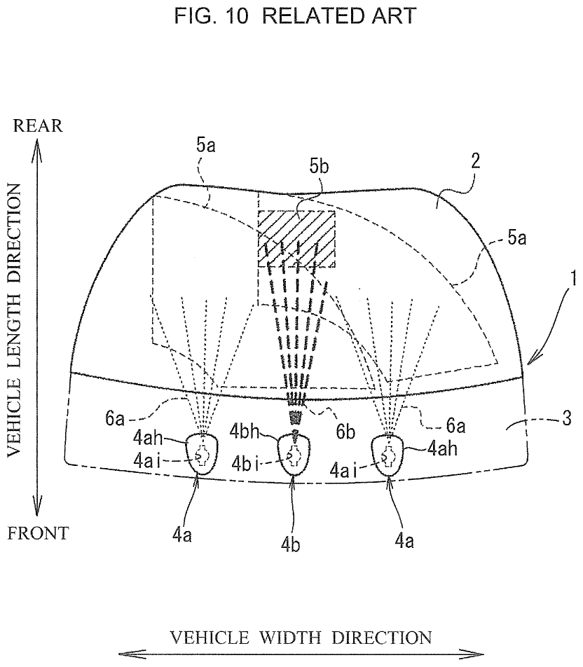

As shown in FIG. 9A, when the insertion tube portion 22 of the jet nozzle 20 is tried to be inserted into the central hole portion 33a of the mounting hole portion 33 for the diffusion nozzle 10, the basal end portion of the insertion tube portion 22 is interfered with the obstacle portions 35 protruded into the central hole portion 33a. This arrangement prevents the insertion tube portion 22 from being inserted into the central hole portion 33a. Thereby, the jet nozzle 20 is blocked from being mounted in the mounting hole portion 33 for the diffusion nozzle 10.

### 4. WHEN THE DIFFUSION NOZZLE 10 IS TRIED TO BE MOUNTED IN THE MOUNTING LOCATION FOR THE JET NOZZLE 20

As mentioned above, in the recessed portion 40 having the mounting hole portion 43 for the jet nozzle 20 formed in the bottom portion 41 thereof, the width W₄₂ between the side wall portions 42, 42 (FIG. 8B) is smaller than the width W₁₁ of the head portion 11 of the diffusion nozzle 10 (FIG. 5A).

As shown in FIG. 9B, when the diffusion nozzle 10 is tried to be mounted in the mounting hole portion 43 for the jet nozzle 20, the head portion 11 of the diffusion nozzle 10 is interfered with the side wall portions 42, 42 of the recessed portion 40. This arrangement prevents the diffusion nozzle 10 from being inserted into the recessed portion 40. Thereby, the diffusion nozzle 10 is blocked from being mounted in the mounting hole portion 43 for the jet nozzle 20.

### 5. EFFECTS OF THE EMBODIMENT

According to the embodiment described above, arrangements are made to block the insertion tube portion 22 of the jet nozzle 20 from being inserted into the mounting hole portion 33 for the diffusion nozzle 10 and to block the head portion 11 of the diffusion nozzle 10 from being inserted into the recessed portion 40 in which the mounting hole portion 43 for the jet nozzle 20 is provided. These arrangements prevent the diffusion nozzle 10 and the jet nozzle 20 from being mounted in wrong mounting holes 43, 33 that are not their respective proper mounting holes by mistake.

### 6. MODIFICATIONS

The present disclosure is not limited to the embodiment described above and various modifications may be adopted without departing from the spirit or scope of the disclosure.

It is not required that the washer nozzles should be mounted in the cowl portion. The washer nozzles may be mounted in another part of the body panel, such as a front hood (bonnet) or a trunk lid.

It is not required that the washer liquid should be ejected onto the front window glass. The washer liquid may be ejected onto another window glass, such as a rear window glass.

It is not required that the first and second nozzles should be the diffusion nozzle and the jet nozzle. The first and second nozzles may be various washer nozzles.

In the embodiment described above, the first mounting hole portion is formed in the bottom portion of the large recessed portion. However, the first mounting hole portion may be formed in the body panel without forming the large recessed portion.

The present disclosure may be applied to a structure for mounting a washer nozzle onto a vehicle body, wherein washer liquid is ejected onto a window glass of a vehicle through the washer nozzle.

According to the present disclosure, the first and second nozzles are prevented from being mounted in wrong mounting holes that are not their respective proper mounting holes by mistake.

Although an example embodiment and modification examples of the disclosure are described hereinabove, the foregoing embodiment and modification examples are mere examples and are not intended to limit the scope of the disclosure. It should be also appreciated that various omissions, replacements, and modifications may be made in the foregoing embodiment and modification examples described herein, without departing from the scope of the disclosure. The disclosure is intended to include such modifications and alterations in so far as they fall within the scope of the appended claims or the equivalents thereof.

1. A mounting structure for a washer nozzle for a vehicle, the mounting structure comprising:
a first nozzle through which washer liquid is ejected onto a window glass of a vehicle;
a second nozzle through which washer liquid is ejected onto the window glass of the vehicle;
a first mounting hole portion formed in a body panel, the first nozzle mounted in the first mounting hole portion;
a second mounting hole portion formed in the body panel, the second nozzle mounted in the second mounting hole portion;
the first nozzle comprising:
a head portion in which an ejection hole is formed; and
an insertion tube portion protruded from a bottom surface of the head portion and to be inserted in the first mounting hole portion;
the second nozzle comprising:
a head portion in which an ejection hole is formed; and
an insertion tube portion protruded from a bottom surface of the head portion and to be inserted in the second mounting hole portion;
the first mounting hole portion having a shape that does not allow the insertion tube portion of the second nozzle to be inserted therein; and
the second mounting hole portion formed in a bottom portion of a recessed portion disposed in the body panel, the recessed portion having dimensions that do not allow the head portion of the first nozzle to be inserted therein.

2. The mounting structure for the washer nozzle for the vehicle according to claim 1, wherein an outer diameter of a basal end portion of the insertion tube portion of the second nozzle is greater than an outer diameter of a basal end portion of the insertion tube portion of the first nozzle,
wherein an obstacle portion protruded toward an inside of the first mounting hole portion is disposed in a peripheral edge portion of the first mounting hole portion of the body panel, and
wherein the obstacle has a shape and dimensions that do not interfere with the basal end portion of the insertion tube portion of the first nozzle but interfere with the basal end portion of the insertion tube portion of the second nozzle that is tried to be inserted into the first mounting hole portion.

3. The mounting structure for the washer nozzle for the vehicle according to claim 2, wherein the first mounting hole portion comprises a cut-out portion formed so as to cut out the peripheral edge portion of the first mounting hole portion,
wherein a spacer portion protruded in a radial direction is disposed in the basal end portion of the insertion tube portion of the first nozzle,
wherein an engagement portion to be inserted in the cut-out portion and engaged with an edge portion of the cut-out portion is disposed in a distal end portion of the spacer portion in a protrusion direction, and
wherein the obstacle portion is protruded from a peripheral edge portion of a portion of the first mounting hole portion other than the cut-out portion so as not to be contacted with the spacer portion.

4. The mounting structure for the washer nozzle for the vehicle according to claim 1, wherein the head portion of the first nozzle and the head portion of the second nozzle have elongated configurations in plan view,
wherein a width of the head portion of the first nozzle is greater than a width of the head portion of the second nozzle,
wherein the recessed portion of the body panel has an elongated configuration in plan view, and
wherein a width of the recessed portion is smaller than the width of the head portion of the first nozzle and greater than the width of the head portion of the second nozzle.

5. The mounting structure for the washer nozzle for the vehicle according to claim 2, wherein the head portion of the first nozzle and the head portion of the second nozzle have elongated configurations in plan view,
wherein a width of the head portion of the first nozzle is greater than a width of the head portion of the second nozzle,
wherein the recessed portion of the body panel has an elongated configuration in plan view, and
wherein a width of the recessed portion is smaller than the width of the head portion of the first nozzle and greater than the width of the head portion of the second nozzle.

6. The mounting structure for the washer nozzle for the vehicle according to claim 3, wherein the head portion of the first nozzle and the head portion of the second nozzle have elongated configurations in plan view,
wherein a width of the head portion of the first nozzle is greater than a width of the head portion of the second nozzle,
wherein the recessed portion of the body panel has an elongated configuration in plan view, and
wherein a width of the recessed portion is smaller than the width of the head portion of the first nozzle and greater than the width of the head portion of the second nozzle.
